(19) United States
(12) Patent Application Publication
(10) Pub. No.: US 2026/0128271 A1
(43) Pub. Date: May 7, 2026

(54) ALL-SOLID-STATE BATTERY AND METHOD OF FABRICATING THE SAME

(71) Applicant: SAMSUNG SDI CO., LTD., Yongin-si (KR)

(72) Inventors: Won Gi LEE, Yongin-si (KR); Jinkyu CHOI, Yongin-si (KR)

(21) Appl. No.: 19/368,666

(22) Filed: Oct. 24, 2025

(30) Foreign Application Priority Data
Nov. 4, 2024 (KR) 10-2024-0154347

(51) Int. Cl. H01M 4/04; H01M 4/02; H01M 10/0562

(52) U.S. Cl. CPC H01M 4/043; H01M 4/0404; H01M 10/0562; H01M 2004/021; H01M 2300/0068

(57) ABSTRACT

Disclosed are all-solid-state batteries and fabrication methods thereof. The method of fabricating an all-solid-state battery includes preparing a first substrate and a second substrate, preparing a first electrode plate by forming a first mixture layer on the first substrate, preparing a second electrode plate by forming a second mixture layer on the second substrate, forming a first electrode by transferring the second mixture layer of the second electrode plate to the first mixture layer of the first electrode plate, and performing a post-pressurization to pressurize the first electrode. The forming of the first electrode comprises performing a pre-pressurization in which the first electrode plate and the second electrode plate are pressurized while facing each other. The post-pressurization further includes cooling the second electrode plate.

### CROSS-REFERENCE TO RELATED APPLICATION

The present application claims priority to and the benefit of Korean Patent Application No. 10-2024-0154347, filed on Nov. 4, 2024, in the Korean Intellectual Property Office, the entire content of which is hereby incorporated by reference.

### BACKGROUND

### 1. Field

Embodiments of the present disclosure relate to an all-solid-state battery and a method of fabricating the same.

### 2. Description of the Related Art

Recently, with the rapid spread of battery using electronic devices, such as mobile phones, laptop computers, and electric vehicles, there is a rapidly increasing interest in rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation are possible, and generates electrical energy caused by oxidation and reduction reactions if (e.g., when) lithium ions are intercalated and deintercalated.

Among rechargeable lithium batteries, an all-solid-state battery refers to a battery in which all materials are solid, and, for example, a battery using a solid electrolyte. Such all-solid-state battery exhibits excellent safety due to no (or substantially no) risk of electrolyte leakage, and a thin-layered battery may readily be fabricated.

Various methods to increase a capacity of the all-solid-state battery are being studied, and one approach to increasing capacity within a limited volume is to manufacture an electrode plate having high current density.

### SUMMARY

An embodiment of the present disclosure provides an all-solid-state battery having high current density and a method of fabricating the same.

An embodiment of the present disclosure provides an all-solid-state battery having a large coating amount of an active material layer and a method of fabricating the same.

According to an embodiment of the present disclosure, a method of fabricating an all-solid-state battery may include: preparing a first substrate and a second substrate; preparing a first electrode plate by forming a first mixture layer on the first substrate; preparing a second electrode plate by forming a second mixture layer on the second substrate; forming a first electrode by transferring the second mixture layer of the second electrode plate to the first mixture layer of the first electrode plate; and performing a post-pressurization to pressurize the first electrode. The forming of the first electrode may include performing a pre-pressurization in which the first electrode plate and the second electrode plate are pressurized while facing each other. The post-pressurization may further include cooling the second electrode plate.

According to an embodiment of the present disclosure, an all-solid-state battery may include: a positive electrode, the positive electrode including a positive electrode current collector, a first mixture layer on the positive electrode current collector, and a second mixture layer on the first mixture layer; a solid electrolyte layer on the second mixture layer; and a negative electrode layer on the solid electrolyte layer. The first mixture layer may include a first positive electrode active material and a first solid electrolyte. The second mixture layer may include a second positive electrode active material and a second solid electrolyte. A weight ratio of the first solid electrolyte in the first mixture layer may be less than a weight ratio of the second solid electrolyte in the second mixture layer.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a cross-sectional view showing an all-solid-state battery according to an embodiment of the present disclosure.

FIGS. 2A and 2B are flow charts showing a method of fabricating an all-solid-state battery according to an embodiment of the present disclosure.

FIGS. 3 to 7 are cross-sectional views showing a method of fabricating an all-solid-state battery according to an embodiment of the present disclosure.

### DETAILED DESCRIPTION

In order to sufficiently understand the configuration and effect of embodiments of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided only to disclose the subject matter of the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of singular form may include the expression of plural form. In embodiments, unless otherwise specially noted, the phrase “A or B” may indicate “A but not B”, “B but not A”, and/or “A and B”. The terms “comprises/includes” and/or “comprising/including” used in this description do not exclude the presence or addition of one or more other components.

In this description, the term “combination thereof” may refer to a mixture, a stack, a composite, a copolymer, an alloy, a blend, and/or a reaction product.

In an electrode for an all-solid-state battery including a current collector, a method to increase a battery capacity within a limited volume through design considerations may include increasing a coating amount of an active material layer on a substrate to manufacture an electrode plate having high current density.

An all-solid-state battery and a method of fabricating the same according to an embodiment of the present disclosure may be utilized to increase a coating amount of a battery active material, to achieve uniformity (e.g., substantial uniformity) of suitable or desired thickness and quality, and to increase current density performance of the battery.

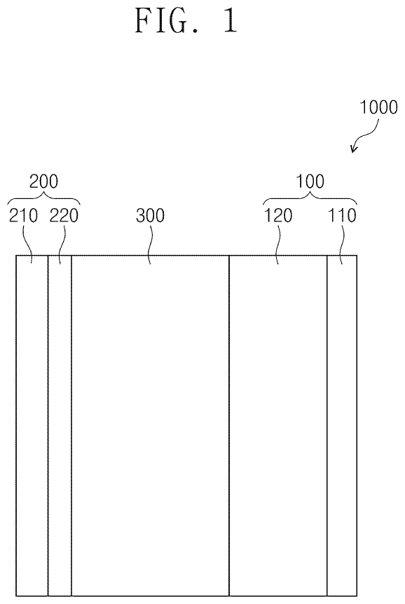

FIG. 1 illustrates an all-solid-state battery according to an embodiment of the present disclosure.

FIG. 1 is a cross-sectional view of an all-solid-state battery 1000 according to an embodiment of the present disclosure.

Referring to FIG. 1, the all-solid-state battery 1000 according to an embodiment may include a positive electrode layer 100, a negative electrode layer 200 opposite to the positive electrode layer 100, and a solid electrolyte layer 300 between the positive electrode layer 100 and the negative electrode layer 200. The present disclosure, however, is not limited thereto, and the all-solid-state battery 1000 may further include an additional functional layer, such as an adhesion enhancement layer, between the positive electrode layer 100 and the solid electrolyte layer 300 or between the negative electrode layer 200 and the solid electrolyte layer 300.

The positive electrode layer 100 according to an embodiment may include a positive electrode current collector 110 and a positive electrode active material layer 120 on the positive electrode current collector 110. The positive electrode active material layer 120 may include a positive electrode active material, a solid electrolyte, a conductive material (e.g., an electrically conductive material), and a binder.

The positive electrode current collector 110 may provide a reference surface on which the positive electrode active material layer 120 is provided. The positive electrode current collector 110 may include a plate and/or foil including, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof.

In embodiments, in order to increase adhesion between the positive electrode current collector 110 and the positive electrode active material layer 120, a carbon layer having a thickness of about 0.1 μm to about 4 μm may further be between the positive electrode current collector 110 and the positive electrode active material layer 120.

The positive electrode active material may be an active material that can reversibly absorb and desorb lithium ions. The positive electrode active material may include lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate), nickel sulfide, copper sulfide, lithium sulfide, iron oxide, and/or vanadium oxide, but the present disclosure is not limited thereto. The positive electrode active material may be used alone or in a mixture of two or more substances.

The positive electrode active material may have a spherical shape (e.g., a generally spherically shape). The positive electrode active material may have an oval shape (e.g., a generally oval shape). There may be no limitation on the shape of the positive electrode active material.

The lithium transition metal oxide may be, for example, a compound represented by one selected from LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}GₑO₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄. In the compounds above, “A” may be Ni, Co, Mn, or a combination thereof, “B” may be Al, Ni, Co, Mn, Cr, Fe, Mg, Sr, V, a rare-earth element, or a combination thereof, “D” may be O, F, S, P, or a combination thereof, “E” may be Co, Mn, or a combination thereof, “F” may be F, S, P, or a combination thereof, “G” may be Al, Cr, Mn, Fe, Mg, La, Ce, Sr, V, or a combination thereof, “Q” may be Ti, Mo, Mn, or a combination thereof, “I” may be Cr, V, Fe, Sc, Y, or a combination thereof, and “J” may be V, Cr, Mn, Co, Ni, Cu, or a combination thereof.

The positive electrode active material may include, for example, lithium salt of transition metal oxide having a layered rock salt type (or kind of) structure among lithium transition metal oxides discussed above. As used herein, the term “layered rock salt type structure” may refer to a structure in which an oxygen atom layer and a metal atom layer are alternately and regularly arranged in a <111> direction of a cubic rock salt type (or kind of) structure, where each atom layer forms a two-dimensional plane. As used herein, the term “cubic rock salt type structure” may refer to a sodium chloride (NaCl) type (or kind of) structure, which is a type (or kind) of crystal structure, and for example, has a structure in which face centered cubic lattices (FCCs) each formed of cations and anions are arranged displaced from each other by ½ of a ridge of a unit lattice. The lithium transition metal oxide having the layered rock salt type (or kind of) structure may be a ternary lithium transition metal oxide, such as LiNiₓCo_{y}Al_{z}O₂ (NCA) and/or LiNiₓCo_{y}Mn_{z}O₂ (NCM) (where 0<x<1, 0<y<1, 0<Z<1, and x+y+z=1). If (e.g., when) the positive electrode active material includes a ternary lithium transition metal oxide having the layered rock salt type (or kind of) structure, the all-solid-state battery 1000 may have increased energy density and improved thermal stability.

The compound included in the positive electrode active material may be covered with a coating layer. The positive electrode active material may be used in a mixture of the compound and a compound to which the coating layer is added. The coating layer added to a surface of the positive electrode active material may include, for example, oxide, hydroxide, oxyhydroxide, oxycarbonate, and/or hydrocarbonate of a coating element discussed below. The compound that constitutes the coating layer may be amorphous and/or crystalline. The coating element included in the coating layer may include Mg, Al, Co, K, Na, Ca, Si, Ti, V, Sn, Ge, Ga, B, As, Zr, and/or a mixture thereof. The coating layer may include, for example, Li₂O—ZrO₂ (LZO). A method for forming the coating layer may be selected within any suitable methods that do not (or substantially do not) adversely affect physical characteristics of the positive electrode active material. The method of forming the coating layer may include, for example, spray coating and/or immersion.

If (e.g., when) the positive electrode active material includes nickel (Ni) as a ternary lithium transition metal oxide such as NCA and/or NCM, a capacity density of the all-solid-state battery 1000 may increase to reduce metal elution from the positive electrode active material in a charged state. Therefore, the all-solid-state battery 1000 may improve in cycle characteristics in a charged state. As used herein, the term “cycle characteristics” may refer to properties that indicate the degree to which the all-solid-state battery 1000 is degraded due to charge and discharge. For example, the all-solid-state battery 1000 having high cycle characteristics may degrade less due to charge and discharge, while the all-solid-state battery 1000 having low cycle characteristics may degrade more due to charge and discharge.

The positive electrode active material may have, for example, a spherical or oval particle shape (e.g., a generally spherical particle shape or a generally oval particle shape). There is no limitation on a particle diameter and an amount of the positive electrode active material.

The solid electrolyte in the positive electrode active material layer 120 may include a sulfide-based solid electrolyte having excellent lithium ionic conductivity. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₁O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one of Ge, Zn, and Ga), Li₂S—GeS₂, Li₂S—SiS₂—Li₃PO₄, Li₂S—SiS₂—LiₚMO_{q} (where p and q are each a positive integer, and “M” is one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one selected from Li₆PS₅Cl, Li₆PS₅Br, and Li₆PS₅I.

In embodiments, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance (e.g., an internal electrical resistance) of an all-solid-state battery and to prevent or reduce formation of short-circuit and/or penetration of a solid electrolyte layer caused by the formation of lithium dendrites. The solid electrolyte may have an elastic modulus of, for example, about 15 GPa to about 35 GPa.

The conductive material may have conductivity (e.g., electrical conductivity) without causing a chemical change (e.g., an undesirable chemical change) of the all-solid-state battery 1000 to increase conductivity (e.g., electrical conductivity) of the positive electrode active material and the solid electrolyte. The conductive material may include a carbon-based material. The conductive material may include, for example, one or more selected from graphite, carbon black, acetylene black, carbon nano-fiber, and carbon nano-tube.

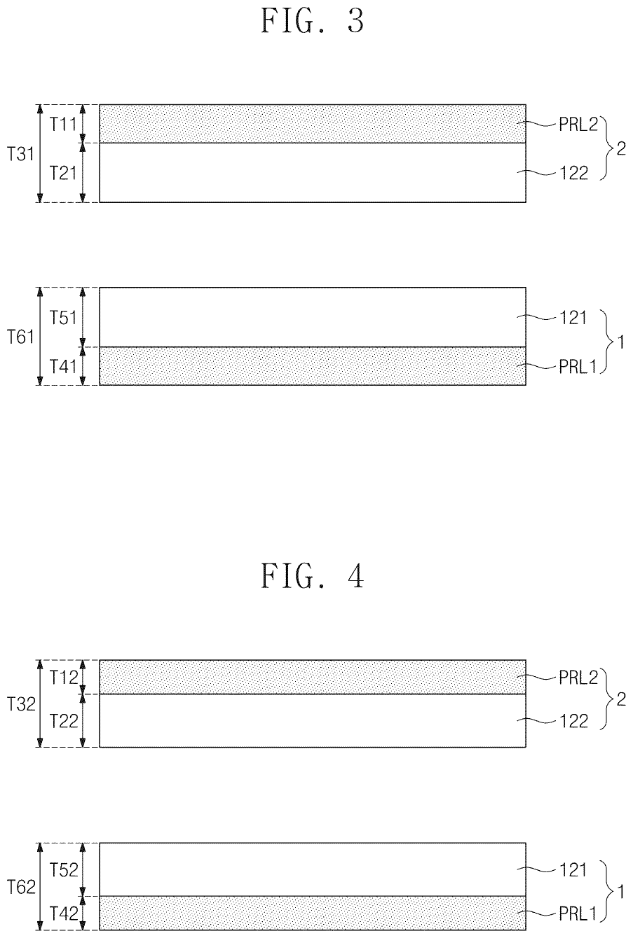

The binder may include a material that adheres to each other the positive electrode active material, the solid electrolyte, and the conductive material and that improves adhesion with a first substrate (see PRL1 of FIG. 3). The binder may include, for example, polyvinylidenefluoride, styrene-butadiene rubber (SBR), polytetrafluoroethylene, vinylidenefluoride/hexafluoropropylene copolymer, polyacrylonitrile, and/or polymethyl methacrylate.

The solid electrolyte layer 300 may be between the positive electrode layer 100 and the negative electrode layer 200, and may include a sulfide-based solid electrolyte having excellent lithium ionic conductivity. The solid electrolyte included in the solid electrolyte layer 300 may include a material that is the same as or different from that of the solid electrolyte included in the positive electrode active material layer 120.

The solid electrolyte layer 300 may further include a binder. The binder included in the solid electrolyte layer 300 may include, for example, styrene-butadiene rubber (SBR), polytetrafluoroethylene, polyvinylidenefluoride, and/or polyethylene, but the present disclosure is not limited thereto. The binder of the solid electrolyte layer 300 may be the same as or different from that of the positive electrode active material layer 120 and/or that of a coating layer 220 which will be further discussed below.

The negative electrode layer 200 may include a negative electrode current collector 210 and a coating layer 220 on the negative electrode current collector 210. The negative electrode current collector 210 may provide a reference surface on which the coating layer 220 is provided. The negative electrode current collector 210 may include a material that does not react with lithium, for example, a material that does not form an alloy or a compound with lithium. For example, the negative electrode current collector 210 may include at least one metal selected from copper (Cu), stainless steel, titanium (Ti), iron (Fe), cobalt (Co), and nickel (Ni). For example, a thickness of the negative electrode current collector 210 may range from about 1 μm to about 20 μm, from about 5 μm to about 15 μm, or from about 7 μm to about 10 μm.

The negative electrode current collector 210 may be formed of one of the metals mentioned above, an alloy of two or more of the metals mentioned above, or a coating material. The negative electrode current collector 210 may have, for example, a plate and/or foil shape. In an embodiment, the negative electrode current collector 210 may not be provided.

The coating layer 220 may induce growth of lithium metal between the coating layer 220 and the negative electrode current collector 210 if (e.g., when) the all-solid-state battery 1000 is charged. The coating layer 220 may serve as a protection layer for lithium metal and concurrently (e.g., simultaneously) may suppress or reduce precipitation and growth of lithium dendrites.

The coating layer 220 may include metal and carbon. For example, the coating layer 220 may include at least one metal selected from gold (Au), platinum (Pt), palladium (Pd), silicon (Si), silver (Ag), aluminum (Al), bismuth (Bi), tin (Sn), and zinc (Zn). The coating layer 220 may include at least one carbon selected from carbon black, acetylene black, furnace black, ketjen black, and graphene. In an embodiment, the coating layer 220 may include a mixture of carbon black and silver (Ag).

The coating layer 220 may further include an additive in addition to metal and carbon. The coating layer 220 may include at least one additive selected from, for example, a binder, a filler, a coating agent, a dispersant, and an ionic conductivity agent.

The coating layer 220 may have a thickness less than that of the positive electrode active material layer 120. For example, the coating layer 220 may have a thickness that is equal to or less than about 50%, 40%, 30%, 20%, 10%, or 5% of that of the positive electrode active material layer 120. The thickness of the coating layer 220 may range, for example, from about 1 μm to about 20 μm, from about 2 μm to about 10 μm, or from about 3 μm to about 7 μm. If (e.g., when) the coating layer 220 has an excessively small thickness, lithium dendrites formed between the coating layer 220 and the negative electrode current collector 210 may collapse the coating layer 220 to reduce cycle characteristics of the all-solid-state battery 1000. If (e.g., when) the coating layer 220 has an excessively large thickness, the all-solid-state battery 1000 may have a reduced energy density, and an internal resistance (e.g., an internal electrical resistance) of the all-solid-state battery 1000 may increase due to the coating layer 220, thereby reducing cycle characteristics of the all-solid-state battery 1000.

In embodiments, a carbon layer may further be included to increase adhesion between the coating layer 220 and the solid electrolyte layer 300.

In an embodiment, the solid electrolyte layer 300 may include a positive electrode solid electrolyte layer and a negative electrode solid electrolyte layer. The positive electrode solid electrolyte layer may be adjacent to the positive electrode layer 100, and the negative electrode solid electrolyte layer may be adjacent to the negative electrode layer 200. Each of the positive and negative electrode solid electrolyte layers may include the solid electrolyte discussed herein.

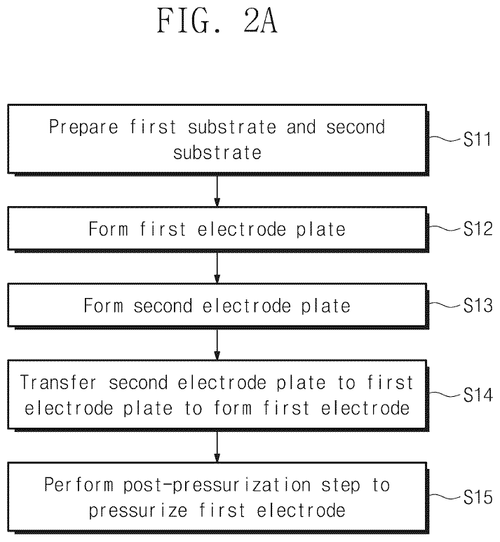

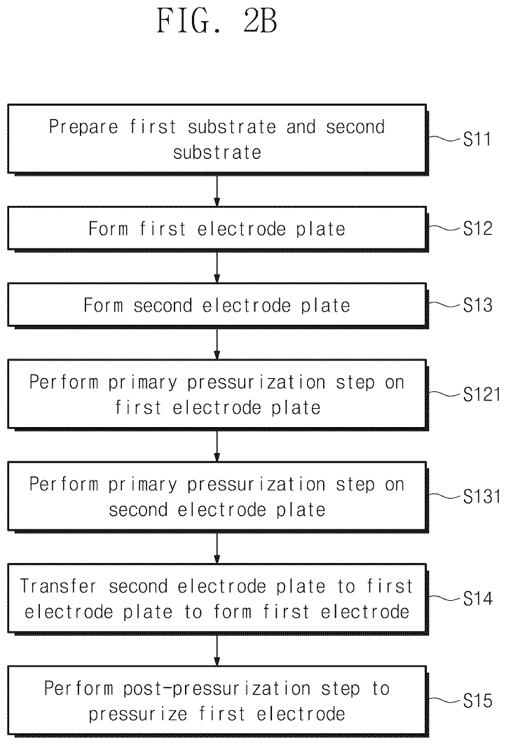

FIG. 2A is a flow chart showing a method of fabricating an all-solid-state battery according to an embodiment of the present disclosure. FIG. 2B is a flow chart showing a method of fabricating an all-solid-state battery according to an embodiment of the present disclosure. FIGS. 3 to 7 are cross-sectional views showing a method of fabricating an all-solid-state battery according to an embodiment of the present disclosure.

Referring to FIG. 2A, a method of fabricating an all-solid-state battery according to embodiments of the present disclosure may include preparing a first substrate and a second substrate (S11), forming a first electrode plate (S12), forming a second electrode plate (S13), providing the second electrode plate on the first electrode plate to form a first electrode (S14), and performing a post-pressurization to pressurize the first electrode (S15).

Referring to FIG. 2B, a method of fabricating an all-solid-state battery according to the present disclosure may include preparing a first substrate and a second substrate (S11), forming a first electrode plate (S12), forming a second electrode plate (S13), performing a primary pressurization on the first electrode plate

(S121), performing a primary pressurization on the second electrode plate (S131), providing the second electrode plate on the first electrode plate to form a first electrode (S14), and performing a post-pressurization to pressurize the first electrode (S15).

A detailed explanation will be provided below with reference to FIGS. 3 to 7.

Referring to FIG. 3, a first substrate PRL1 may be prepared. A first mixture layer 121 may be provided on the first substrate PRL1. The first mixture layer 121 may be provided on the first substrate PRL1 to form a first electrode plate 1. For example, a first positive electrode slurry may be coated and dried on the first substrate PRL1 to form the first mixture layer 121. Thus, the first electrode plate 1 may be formed which includes the first substrate PRL1 and the first mixture layer 121.

A second substrate PRL2 may be prepared to face the first substrate PRL1. A second mixture layer 122 may be provided on the second substrate PRL2. The second mixture layer 122 may be provided on the second substrate PRL2 to form a second electrode plate 2. For example, a second positive electrode slurry may be coated and dried on the second substrate PRL2 to form the second mixture layer 122. Thus, the second electrode plate 1 may be formed which includes the second substrate PRL2 and the second mixture layer 122.

The first substrate PRL1 may be a current collector. The first substrate PRL1 may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof.

The first mixture layer 121 may include a positive electrode active material, a first solid electrolyte, a conductive material (e.g., an electrically conductive material), and a binder.

Based on the total 100 parts by weight of the positive electrode active material, the first solid electrolyte, the conductive material, and the binder, the positive electrode active material may be included in an amount of about 83 parts by weight to about 92 parts by weight in the first mixture layer 121.

Based on the total 100 parts by weight of the positive electrode active material, the first solid electrolyte, the conductive material, and the binder, a weight ration of the first solid electrolyte may be equal to or less than about 15 parts by weight. For example, in the first mixture layer 121, a weight ratio of the first solid electrolyte may range from about 10 wt % to about 18 wt % based on 100 wt % of the first mixture layer.

Based on the total 100 parts by weight of the positive electrode active material, the first solid electrolyte, the conductive material, and the binder, the binder may be included in an amount of about 0.5 parts by weight to about 1.5 parts by weight in the first mixture layer 121.

Based on 100 parts by weight of the first solid electrolyte, the conductive material may be included in an amount of about 1 part by weight to about 10 parts by weight in the first mixture layer 121. If (e.g., when) the conductive material is included in an amount of equal to or less than about 1 part by weight relative to 100 parts by weight of the first solid electrolyte, a proportion of the conductive material may decrease to reduce electrical conductivity of the first mixture layer 121. If (e.g., when) the conductive material is included in an amount of equal to or greater than about 10 parts by weight relative to 100 parts by weight of the first solid electrolyte, a proportion of the conductive material may excessively increase to cause incomplete formation of a coating layer that covers a surface of the first solid electrolyte.

The first mixture layer 121 may further include an additive, such as a filler, a coating agent, a dispersant, and an ionic conductivity agent, in addition to the positive electrode active material, the first solid electrolyte, the conductive material, and the binder.

The second substrate PRL2 may be the same as the first substrate PRL1. The second mixture layer 122 may include a positive electrode active material, a second solid electrolyte, a conductive material (e.g., an electrically conductive material), and a binder. The positive electrode active material may be included in an amount of about 65 parts by weight to about 90 parts by weight in the second mixture layer 122, and except that a weight ratio of the second solid electrolyte is about 20 wt % to about 40 wt % in the second mixture layer 122 based on 100 wt % of the first mixture layer, the second mixture layer 122 may be the same as the first mixture layer 121. A weight ratio of the first solid electrolyte in the first electrode plate 1 may be less than that of the second solid electrolyte in the second electrode plate 2.

Referring back to FIG. 3, the first substrate PRL1 may have a non-treated first substrate thickness T41. The non-treated first substrate thickness T41 of the first substrate PRL1 may be defined to refer to a thickness where no pressure is applied to the first substrate PRL1.

The first substrate PRL1 may be provided thereon with the first mixture layer 121 having a non-treated first mixture layer thickness T51. The non-treated first mixture layer thickness T51 may be defined to refer to a thickness where no pressure is applied to the first mixture layer 121.

The first electrode plate 1 may have a non-treated first electrode plate thickness T61. The non-treated first electrode plate thickness T61 may be defined to refer to a thickness in the case where no pressure is applied to the first electrode plate 1. The non-treated first electrode plate thickness T61 of the first electrode plate 1 may be substantially the same as a sum of the non-treated first mixture layer thickness T51 and the non-treated first substrate thickness T41. In this description, the phrase “substantially the same” may indicate an average error range of about 5% more or less.

The second substrate PRL2 may have a non-treated second substrate thickness T11. The non-treated second substrate thickness T11 of the second substrate PRL2 may be defined to refer to a thickness where no pressure is applied to the second substrate PRL2.

The second substrate PRL2 may be provided thereon with the second mixture layer 122 having a non-treated second mixture layer thickness T21. The non-treated second mixture layer thickness T21 may be defined to refer to a thickness where no pressure is applied to the second mixture layer 122.

The second electrode plate 2 may have a non-treated second electrode plate thickness T31. The non-treated second electrode plate thickness T31 may be defined to refer to a thickness where no pressure is applied to the second electrode plate 2. The non-treated second electrode plate thickness T31 of the second electrode plate 2 may be substantially the same as a sum of the non-treated second mixture layer thickness T21 and the non-treated second substrate thickness T11. In this description, the phrase “substantially the same” may indicate an average error range of about 5% more or less.

The first electrode plate 1 may include a coating layer including carbon. A coating layer may be additionally provided on the first mixture layer 121. In embodiments, the first electrode plate 1 may include the first substrate PRL1, the first mixture layer 121, and a coating layer. A thickness of the coating layer may be equal to or less than about 3 μm.

Referring to FIG. 4, the primary pressurization S121 may be performed to pressurize the first electrode plate 1. After the first mixture layer 121 is provided on the first substrate plate PRL1 to form the first electrode plate 1, the first electrode plate 1 may be pressurized in the first primary pressurization S121 of the first electrode plate 1. The primary pressurization S121 may include pressurizing the first electrode plate 1 at a pressure of about 0.1 tons/cm to about 0.3 tons/cm. After the primary pressurization S121 is performed on the first electrode plate 1, the first substrate PRL1, the first mixture layer 121, and the first electrode plate 1 may have their reduced thicknesses.

After the primary pressurization S121, the first substrate PRL1 may have a primary-pressurization-treated first substrate thickness T42. The treated first substrate thickness T42 may be less than the non-treated first substrate thickness T41.

After the primary pressurization S121, the first mixture layer 121 may have a primary-pressurization-treated first mixture layer thickness T52. The treated first mixture layer thickness T52 may be less than the non-treated first mixture layer thickness T51.

After the primary pressurization S121, the first electrode plate 1 may have a primary-pressurization-treated first electrode plate thickness T62. The treated first electrode plate thickness T62 may be less than the non-treated first electrode plate thickness T61.

Concurrently (e.g., simultaneously) with or sequentially after the primary pressurization S121, a primary pressurization S131 may be performed on the second electrode plate 2. In the primary pressurization S131, the second electrode plate 2 may be pressurized. After the second mixture layer 122 is provided on the second substrate plate PRL2 to form the second electrode plate 2, the second electrode plate 2 may be pressurized in the first primary pressurization S131 of the second electrode plate 2. The primary pressurization S131 of the second electrode plate 2 may include pressurizing the second electrode plate 2 at a pressure of about 0.1 tons/cm to about 0.3 tons/cm. After the primary pressurization S131 is performed on the second electrode plate 2, the second substrate PRL2, the second mixture layer 122, and the second electrode plate 1 may have their reduced thicknesses.

After the primary pressurization S131, the second substrate PRL2 may have a primary-pressurization-treated second substrate thickness T12. The treated second substrate thickness T12 may be less than the non-treated second substrate thickness T11.

After the primary pressurization S131, the second mixture layer 122 may have a primary-pressurization-treated second mixture layer thickness T22. The treated second mixture layer thickness T22 may be less than the non-treated second mixture layer thickness T21.

After the primary pressurization S131, the second electrode plate 2 may have a primary-pressurization-treated second electrode plate thickness T32. The treated second electrode plate thickness T32 may be less than the non-treated second electrode plate thickness T31.

The treated first electrode plate thickness T62 may be substantially the same as a sum of the treated first mixture layer thickness T52 and the treated first substrate thickness T42.

The treated second electrode plate thickness T32 may be substantially the same as a sum of the treated second mixture layer thickness T22 and the treated second substrate thickness T12.

Referring to FIG. 5, the providing S14 may be performed such that the second electrode plate 2 is transferred to the first electrode plate 1 to form a first electrode 10. The providing S14 of forming the first electrode 10 may include allowing the second mixture layer 122 of the second electrode plate 2 to come into face-to-face contact with the first mixture layer 121 of the first electrode plate 1.

The providing S14 of forming the first electrode 10 may include performing a pre-pressurization in which the first electrode plate 1 and the second electrode plate 2 are pressurized while facing each other. In embodiments, the pre-pressurization may include pressurizing the first electrode plate 1 and the second electrode plate 2 at a pressure of about 0.3 tons/cm to about 0.5 tons/cm.

As the providing S14 includes facing and pressurizing the first electrode plate 1 and the second electrode plate 2, each of the first electrode plate 1 and the second electrode plate 2 may have a reduced thickness. For example, the first electrode plate 1 of the first electrode 10 may have a thickness T63 less than the treated first electrode plate thickness T62. The second electrode plate 2 of the first electrode 10 may have a thickness T33 less than the treated second electrode plate thickness T32.

A thickness T7 of the first electrode 10 may be a sum of the thickness T63 of the first electrode plate 1 and the thickness T33 of the second electrode plate 2. The thickness T7 of the first electrode 10 may be less than a sum of the treated first electrode plate thickness T62 and the treated second electrode plate thickness T32.

The first substrate PRL1 of the first electrode 10 may have a thickness T43 less than the treated first substrate thickness T42. The first mixture layer 121 of the first electrode 10 may have a thickness T53 less than the treated first mixture layer thickness T52.

The second substrate PRL2 of the first electrode 10 may have a thickness T13 less than the treated second substrate thickness T12. The second mixture layer 122 of the first electrode 10 may have a thickness T23 less than the treated second mixture layer thickness T22.

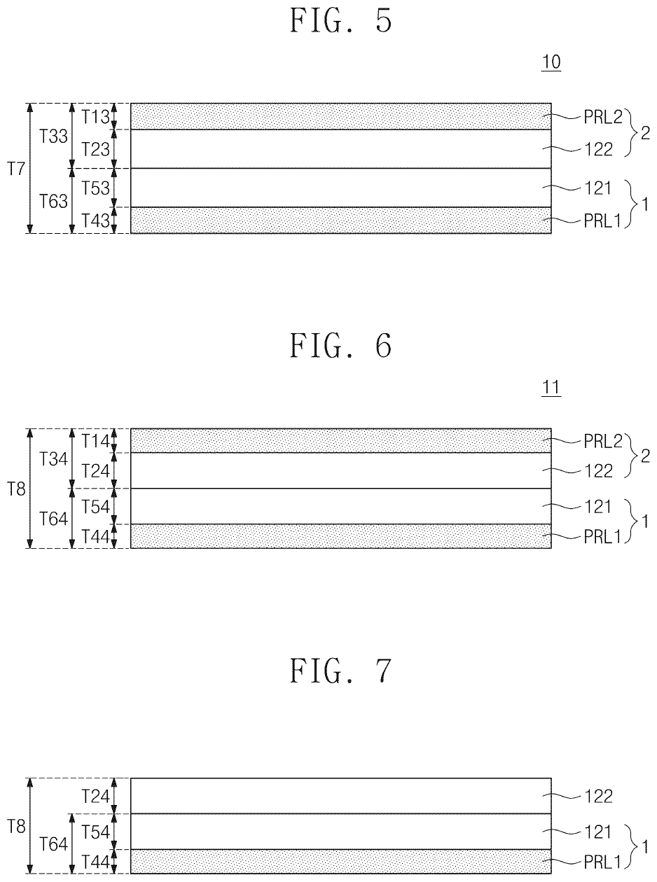

Referring to FIG. 6, the post-pressurization S15 may be performed to pressurize the first electrode 10. The first electrode 10 may be post-pressurized to form a first pressurized electrode 11. The post-pressurization S15 may further include cooling the second electrode plate 2. The cooling of the second electrode plate 2 may include using liquid nitrogen to cool the second electrode plate 2. The post-pressurization S15 may include pressurizing the first electrode plate 1 at a pressure of about 2.0 tons/cm to about 2.5 tons/cm.

The cooling of the second electrode plate 2 may include, for example, treating the first electrode 10 for about 10 minutes to about 20 minutes at about −200° C. to about −196° C. under a liquid nitrogen atmosphere.

The first pressurized electrode 11 may be formed by cooling the second electrode plate 2 of the first electrode and pressurizing the first electrode 10.

A thickness T8 of the first pressurized electrode 11 may be less than the thickness T7 of the first electrode 10. The first electrode plate 1 of the first pressurized electrode 11 may have a thickness T64 less than a thickness T63 of the first electrode plate 1 of the first electrode 10. The second electrode plate 2 of the first pressurized electrode 11 may have a thickness T34 less than a thickness T33 of the second electrode plate 2 of the first electrode 10. The first substrate PRL1 of the first pressurized electrode 11 may have a thickness T44 less than a thickness T43 of the first substrate PRL1 of the first electrode 10. The second substrate PRL2 of the first pressurized electrode 11 may have a thickness T14 less than a thickness T13 of the second substrate PRL2 of the first electrode 10.

Referring to FIG. 7, a removal may be performed to remove the second substrate PRL2 that is cooled after the post-pressurization S15. Because the second electrode plate 2 is cooled in the post-pressurization S15, the second substrate PRL2 may be more easily removed capered to if (e.g., when) the second substrate PRL2 is not cooled.

In the second electrode plate 2 where the first electrode 10 is cooled under a liquid nitrogen atmosphere, the second substrate PRL2 on the second electrode plate 2 may be removed. The second substrate PRL2 may be cooled as discussed herein, and thus may be more easily removed.

A solid electrolyte layer and a negative electrode plate may be stacked on the second mixture layer 122 exposed due to the removal of the second substrate PRL2. Accordingly, an all-solid-state battery may be fabricated.

In an embodiment of the all-solid-state battery fabricated through the method discussed above, based on the positive electrode active material layer 120 on one side of the positive electrode current collector 110, the positive electrode active material layer 120 may have a loading level of about 15 mg/cm² to about 60 mg/cm². For example, the positive electrode active material layer 120 on one side of the positive electrode current collector 110 may have a loading level of about 15 mg/cm² to about 60 mg/cm². In embodiments, if (e.g., when) the positive electrode active material layers 120 are coated on opposite sides of the positive electrode current collector 110 may have a total loading level of about 30 mg/cm² to about 120 mg/cm². In this description, the expression “a loading level of the positive electrode active material layer” may refer to a weight of positive electrode material per unit area of the positive electrode active material layer.

The second electrode plate 2 of the all-solid-state battery fabricated through the method discussed above may be treated with liquid nitrogen. One lateral surface of the second electrode plate 2 may be in contact with the first electrode plate 1, and another lateral surface of the second electrode plate 2 may be in contact with the solid electrolyte layer.

### Embodiment 1

### Manufacture of Positive Electrode

A powder of LiNi_{0.8}Co_{0.15}Mn_{0.05}O₂ (NCM) was prepared as a positive electrode active material. There were prepared argyrodite-type first solid electrolyte particles (Li₆PS₅Cl) having an average particle diameter (D₅₀) of 1 μm as a solid electrolyte, polyvinylidene fluoride (PVdF) as a binder, and carbon nano-fiber (CNF) as a conductive material.

The positive electrode active material, the solid electrolyte, the conductive material, and the binder were mixed in a weight ratio of 85:13.5:0.5:1 in an octyl acetate solvent to prepare a first positive electrode slurry. The first positive electrode slurry was coated on an aluminum positive electrode current collector, and then dried and pressed to manufacture a positive electrode plate.

A powder of LiNi_{0.8}Co_{0.15}Mn_{0.05}O₂ (NCM) was prepared as a positive electrode active material. There were prepared argyrodite-type second solid electrolyte particles (Li₆PS₅Cl) with an average particle diameter (D₅₀) of 1 μm as a solid electrolyte, polyvinylidene fluoride (PVdF) as a binder, and carbon nano-fiber (CNF) as a conductive material.

The positive electrode active material, the solid electrolyte, the conductive material, and the binder were mixed in a weight ratio of 78.5:20:0.5:1 in an N-methyl pyrrolidone solvent to prepare a second positive electrode slurry. The second positive electrode slurry was coated on an aluminum substrate, and then dried and pressed to manufacture a second electrode plate.

The first electrode plate and the second electrode plate were in face-to-face contact with each other, and then cooled for 15 minutes at −196° C. under a liquid nitrogen atmosphere while being pressurized at 2.5 tons/cm.

Afterwards, the aluminum substrate on the second positive electrode slurry was removed.

### Manufacture of Solid Electrolyte Layer

Argyrodite-type third solid electrolyte particles (Li₆PS₅Cl) with an average particle diameter (D₅₀) of 3 μm was added to an isobutylyl isobutylate binder solution added with a butyl acrylate-based polymer to prepare a solid electrolyte slurry (the solid electrolyte and the binder were mixed in a weight ratio of 98.7:1.3). The prepared solid electrolyte slurry was coated on a release polytetrafluoroethylene film, and dried for 2 hours at 60° C. to manufacture a solid electrolyte layer of 100 μm in thickness.

### Manufacture of Negative Electrode

90 wt % of Ag nano-particles (D₅₀: 60 nm) and 10 wt % of carbon black were mixed in a water solvent to prepare a negative electrode coating layer slurry. A mixture of single particles having a particle diameter of 38 nm and secondary particles was used as the carbon black, and the secondary particle was composed of primary particles having a particle diameter of 76 nm and had a particle size of 275 nm. The slurry was coated on a stainless still foil as a current collector, and then dried to manufacture a negative electrode including a negative electrode coating layer of 12 μm in thickness and a current collector of 10 μm in thickness.

### Fabrication of All-Solid-State Battery

The positive electrode, the solid electrolyte layer, and the negative electrode were stacked, and an isostatic pressing was performed for about 30 minutes at a temperature of 85° C. under a pressure of 500 MPa, thereby fabricating an all-solid-state battery.

### Embodiment 2

An all-solid-state battery was fabricated in substantially the same method as in Embodiment 1, except that the positive electrode active material, the solid electrolyte, the conductive material, and the binder were mixed in a weight ratio of 87:11.5:0.5:1 when the first positive electrode slurry was prepared in manufacturing the first electrode plate.

### Embodiment 3

An all-solid-state battery was fabricated in substantially the same method as in Embodiment 1, except that the positive electrode active material, the solid electrolyte, the conductive material, and the binder were mixed in a weight ratio of 83:15.5:0.5:1 when the first positive electrode slurry was prepared in manufacturing the first electrode plate.

### Embodiment 4

An all-solid-state battery was fabricated in substantially the same method as in Embodiment 1, except that the positive electrode active material, the solid electrolyte, the conductive material, and the binder were mixed in a weight ratio of 73.5:25:0.5:1 when the second positive electrode slurry was prepared in manufacturing the second electrode plate.

### Embodiment 5

An all-solid-state battery was fabricated in substantially the same method as in Embodiment 1, except that the positive electrode active material, the solid electrolyte, the conductive material, and the binder were mixed in a weight ratio of 68.5:30:0.5:1 when the second positive electrode slurry was prepared in manufacturing the second electrode plate.

### Comparative Example 1

### Manufacture of Positive Electrode

A powder of LiNi_{0.8}Co_{0.15}Mn_{0.05}O₂ (NCM) was prepared as a positive electrode active material. There were prepared argyrodite-type first solid electrolyte particles (Li₆PS₅Cl) having an average particle diameter (D₅₀) of 1 μm as a solid electrolyte, polyvinylidene fluoride (PVdF) as a binder, and carbon nano-fiber (CNF) as a conductive material. The positive electrode active material, the solid electrolyte, the conductive material, and the binder were mixed in a weight ratio of 85:13.5:0.5:1 in an N-methyl pyrrolidone solvent to prepare a first positive electrode slurry.

A powder of LiNi_{0.8}Co_{0.15}Mn_{0.05}O₂ (NCM) was prepared as a positive electrode active material. There were prepared argyrodite-type second solid electrolyte particles (Li₆PS₅Cl) having an average particle diameter (D₅₀) of 1 μm as a solid electrolyte, polyvinylidene fluoride (PVdF) as a binder, and carbon nano-fiber (CNF) as a conductive material. The positive electrode active material, the solid electrolyte, the conductive material, and the binder were mixed in a weight ratio of 78.5:20:0.5:1 in an N-methyl pyrrolidone solvent to prepare a second positive electrode slurry.

The first positive electrode slurry and the second positive electrode slurry were sequentially coated on an aluminum positive electrode current collector, and then dried and pressed to manufacture as first positive electrode plate.

### Manufacture of Solid Electrolyte Layer

Argyrodite-type third solid electrolyte particles (Li₆PS₅Cl) having an average particle diameter (D₅₀) of 3 μm was added to an isobutylyl isobutylate binder solution added with a butyl acrylate-based polymer to prepare a solid electrolyte slurry (the solid electrolyte and the binder were mixed in a weight ratio of 98.7:1.3). The prepared solid electrolyte slurry was coated on a release polytetrafluoroethylene film, and dried for 2 hours at 60° C. to manufacture a solid electrolyte layer of 100 μm in thickness.

### Manufacture of Negative Electrode

90 wt % of Ag nano-particles (D₅₀: 60 nm) and 10 wt % of carbon black were mixed in a water solvent to prepare a negative electrode coating layer slurry. A mixture of single particles having a particle diameter of 38 nm and secondary particles was used as the carbon black, and the secondary particle was composed of primary particles having a particle diameter of 76 nm and had a particle size of 275 nm. The slurry was coated on a stainless still foil as a current collector, and then dried to manufacture a negative electrode including a negative electrode coating layer of 12 μm in thickness and a current collector of 10 μm in thickness.

### Fabrication of All-Solid-State Battery

The positive electrode, the solid electrolyte layer, and the negative electrode were stacked, and an isostatic pressing was performed for about 30 minutes at a temperature of 85° C. under a pressure of 500 MPa, thereby fabricating an all-solid-state battery.

### Comparative Example 2

A positive electrode, a solid electrolyte layer, a negative electrode, and an all-solid-state battery were fabricated in the same method as in Embodiment 1, except that the positive electrode active material, the solid electrolyte, the conductive material, and the binder were mixed in a weight ratio of 85:13.5:0.5:1 when the second positive electrode slurry was prepared.

### Comparative Example 3

A positive electrode, a solid electrolyte layer, a negative electrode, and an all-solid-state battery were fabricated in the same method as in Embodiment 1, except that the positive electrode active material, the solid electrolyte, the conductive material, and the binder were mixed in a weight ratio of 81:17.5:0.5:1 when the first positive electrode slurry was prepared.

### Evaluation 1: Ionic Conductivity of Positive Electrode

The following method was employed to measure ionic conductivities of cells according to the Examples and Comparative Examples. Each of the positive electrodes in Embodiments 1 to 5 and Comparative Examples 1 to 3 was sampled having a thickness of 150 μm and a diameter of 12 mm. An impedance analyzer (Solartron 1260A Impedance/Gain-Phase Analyzer) was used to measure impedance in accordance with a 2-probe method and to obtain an Nyquist plot (25° C., frequency range: 500 kHz to 50 mHz, amplitude voltage: 50 mV). Based on the measured Nyquist plot results, an equivalent circuit model was applied for fitting to calculate electronic conductivity and ionic conductivity of the cell. The results are listed in Table 1.

TABLE 1

| | Ionic conductivity | Electronic conductivity |
|---|---|---|
| | [mS/cm] | [mS/cm] |
| Embodiment 1 | 0.122 | 0.683 |
| Embodiment 2 | 0.115 | 0.694 |
| Embodiment 3 | 0.149 | 0.671 |
| Embodiment 4 | 0.166 | 0.619 |
| Embodiment 5 | 0.17 | 0.588 |
| Comparative | 0.07 | 0.381 |
| Example 1 | | |
| Comparative | 0.025 | 0.510 |
| Example 2 | | |
| Comparative | 0.145 | 0.024 |
| Example 3 | | |

Referring to Table 1, it may be observed that the ionic conductivity and the electronic conductivity of the positive electrode according to Embodiment 1 are less than those of the positive electrodes according to Comparative Examples 1 to 3. The low ionic conductivity of Comparative Example 1 and the low electronic conductivity of Comparative Example 3 cause high resistances during battery operations to limit outputs. It may be ascertained that both of the ionic conductivity and the electronic conductivity are excellent in the case of the Embodiments.

### Evaluation 2: Lifetime Characteristics

The all-solid-state batteries according to Embodiments 1 to 5 and Comparative Examples 1 to 3 were charged and discharged. A first charge and discharge was performed at 45° C. under the following condition. Charge (0.33 C, CC/CV charge, 4.25 V, 0.05 C cut) and discharge (0.33 C, CC discharge, 3.0 V cut). The charge and discharge were performed under the following condition at a second time and thereafter. Charge (1.0 C, CC/CV charge, 4.25 V, 0.05 C cut) and discharge (0.5 C, CC discharge, 3.0 V cut). A cycle count (cyc) at which capacity retention rate (SOH) reaches 80% after repeated charge and discharge was defined as lifetime characteristics. The charge retention rate at an N^{th} cycle was calculated according to Equation 2.

$$Capacity retention rate [ \% ] = ( discharge capacity at {N}^{th} cycle / discharge capacity at first cycle ) \times 100 \qquad Equation 2$$

TABLE 2

| | Lifetime characteristics (the number of charge- |
|---|---|
| | discharge cycles when SOH reaches 80%) |
| Embodiment 1 | 200 |
| Embodiment 2 | 200 |
| Embodiment 3 | 200 |
| Embodiment 4 | 190 |
| Embodiment 5 | 180 |
| Comparative | 130 |
| Example 1 | |
| Comparative | 10 |
| Example 2 | |
| Comparative | 10 |
| Example 3 | |

As shown in Table 2, it may be observed that the lifetime characteristics of Embodiments 1 to 5 are superior to those of Comparative Examples 1 to 3.

According to an all-solid-state battery and its fabrication method in accordance with embodiments of the present disclosure, a coating amount of an active material layer may increase to manufacture an electrode plate having a high current density.

According to a method of fabricating an all-solid-state battery according to embodiments of the present disclosure, it may be easy to fabricate and suitable for mass production.

While the subject matter of this disclosure has been described in connection with what is presently considered to be example embodiments, it is to be understood that the present disclosure is not limited to the disclosed embodiments and is intended to cover various suitable modifications and equivalent arrangements included within the spirit and scope of the appended claims and equivalents thereof, and therefore the aforementioned embodiments should be understood to be examples but not limiting this disclosure in any way.

What is claimed is:

1. A method of fabricating an all-solid-state battery, the method comprising:
preparing a first substrate and a second substrate;
preparing a first electrode plate by forming a first mixture layer on the first substrate;
preparing a second electrode plate by forming a second mixture layer on the second substrate;
forming a first electrode by transferring the second mixture layer of the second electrode plate to the first mixture layer of the first electrode plate; and
performing a post-pressurization to pressurize the first electrode,
wherein the forming the first electrode comprises performing a pre-pressurization in which the first electrode plate and the second electrode plate are pressurized while facing each other, and
wherein the post-pressurization further comprises cooling the second electrode plate.

2. The method as claimed in claim 1, wherein:
the forming the first mixture layer comprises coating a first positive electrode slurry on the first substrate, and
the forming the second mixture layer comprises coating a second positive electrode slurry on the second substrate.

3. The method as claimed in claim 1, further comprising, before transferring the second mixture layer to the first mixture layer:
performing a primary pressurization to pressurize the first electrode plate; and
performing a primary pressurization to pressurize the second electrode plate.

4. The method as claimed in claim 3, wherein:
the primary pressurization of the first electrode plate is performed such that the first electrode plate is pressurized at about 0.1 tons/cm to about 0.3 tons/cm, and
the primary pressurization of the second electrode plate is performed such that the second electrode plate is pressurized at about 0.1 tons/cm to about 0.3 tons/cm.

5. The method as claimed in claim 1, further comprising removing the second substrate that is cooled after the post-pressurization.

6. The method as claimed in claim 1, wherein the first substrate and the second substrate comprise aluminum.

7. The method as claimed in claim 1, wherein the post-pressurization comprises pressurizing the first electrode at about 2.0 tons/cm to about 2.5 tons/cm.

8. The method as claimed in claim 1, wherein the pre-pressurization comprises arranging the first electrode plate and the second electrode plate to face each other and pressurizing the first electrode plate and the second electrode plate at about 0.3 tons/cm to about 0.5 tons/cm.

9. The method as claimed in claim 1, wherein:
the first mixture layer comprises a first solid electrolyte,
the second mixture layer comprises a second solid electrolyte,
a weight ratio of the first solid electrolyte in the first mixture layer is about 10 wt % to about 18 wt % based on 100 wt % of the first mixture layer, and
a weight ratio of the second solid electrolyte in the second mixture layer is about 20 wt % to about 40 wt % based on 100 wt % of the second mixture layer.

10. The method as claimed in claim 1, wherein cooling the second electrode plate uses liquid nitrogen.

11. An all-solid-state battery, comprising:
a positive electrode, the positive electrode comprising a positive electrode current collector, a first mixture layer on the positive electrode current collector, and a second mixture layer on the first mixture layer;
a solid electrolyte layer on the second mixture layer; and
a negative electrode layer on the solid electrolyte layer,
wherein the first mixture layer comprises a first positive electrode active material and a first solid electrolyte,
wherein the second mixture layer comprises a second positive electrode active material and a second solid electrolyte, and
wherein a weight ratio of the first solid electrolyte in the first mixture layer is less than a weight ratio of the second solid electrolyte in the second mixture layer.

12. The all-solid-state battery as claimed in claim 11, wherein:
the weight ratio of the first solid electrolyte in the first mixture layer is about 10 wt % to about 18 wt % based on 100 wt % of the first mixture layer, and
the weight ratio of the second solid electrolyte in the second mixture layer is about 20 wt % to about 40 wt % based on 100 wt % of the second mixture layer.

13. The all-solid-state battery as claimed in claim 11, further comprising a coating layer between the first mixture layer and the second mixture layer, the coating layer comprising carbon.

14. The all-solid-state battery as claimed in claim 13, wherein a thickness of the coating layer is about 0 μm to about 3 μm.

15. The all-solid-state battery as claimed in claim 11, wherein a loading level on one side of a mixture layer comprising the first mixture layer and the second mixture layer is about 30 mg/cm² to about 35 mg/cm².

16. The all-solid-state battery as claimed in claim 11, wherein the positive electrode current collector comprises aluminum.

17. The all-solid-state battery as claimed in claim 16, wherein the first solid electrolyte comprises a sulfide-based solid electrolyte.

18. The all-solid-state battery as claimed in claim 17, wherein the second solid electrolyte comprises a sulfide-based solid electrolyte.

19. The all-solid-state battery as claimed in claim 11, wherein the second mixture layer is treated with liquid nitrogen.

20. The all-solid-state battery as claimed in claim 11, wherein:
one lateral surface of the second mixture layer is in contact with the first mixture layer, and
another lateral surface of the second mixture layer is in contact with the solid electrolyte layer.
